(19) United States
(12) Patent Application Publication
(10) Pub. No.: US 2012/0185774 A1
(43) Pub. Date: Jul. 19, 2012

(54) Symphonic Video Generation

(75) Inventors: Andrew David PERLMAN, New York, NY (US); Ross Gallagher Neumann, NY, NY (US)

(73) Assignee: Vringo Inc, Beit Shemesh (IL)

(21) Appl. No.: 13/329,487

(22) Filed: Dec. 19, 2011

Related U.S. Application Data
(60) Provisional application No. 61/424,647, filed on Dec. 19, 2010.

(51) Int. Cl. G06F 3/00

(52) U.S. Cl. 715/723

(57) ABSTRACT

A symphonic video clip generator implementable on a programmable mobile device, the generator includes a soundboard, a recorder and a generator. The soundboard is displayed on a screen of the programmable mobile device and displays multiple individually selectable video segments, each occupying a portion of the screen and each having a single associated audio track. The recorder records user activation and deactivation of the selectable video segments with the segments playing once activated and any activated segments playing concurrently. The generator creates a symphonic video clip from output of the recorder. The generator generates a collage of the concurrently activated video segments and a mix of concurrently activated audio tracks according to the timing of the user activation and deactivation for each activated video segment.

### CROSS-REFERENCE TO RELATED APPLICATIONS

This application claims benefit from U.S. Provisional Patent Application No. 61/424,647, filed 19 Dec. 2010 which is hereby incorporated in its entirety by reference.

### FIELD OF THE INVENTION

The present invention relates to symphonic video generation and its application to programmable mobile communication devices in particular.

### BACKGROUND OF THE INVENTION

People love music. They love to listen to it and to share it with friends. Some people, like disc jockeys and musicians, like to mix different songs together, either linking them one after another or creating a medley of them.

There exists an iPhone application called Romplr (www.romplr.com), which enables users to remix tracks of existing songs or groups of songs to generate new and interesting melodies. These new mixes can be sent to and shared with other users, friend via email and different social networking programs such as Facebook.

### SUMMARY OF THE PRESENT INVENTION

There is provided, in accordance with a preferred embodiment of the present invention, a symphonic video clip generator implementable on a programmable mobile device. The symphonic video clip generator includes a soundboard, a recorder and a generator. The soundboard is displayed on a screen of the programmable mobile device and displays multiple individually selectable video segments, each occupying a portion of the screen and each having a single associated audio track. The recorder records user activation and deactivation of the selectable video segments with the segments playing once activated and any activated segments playing concurrently. The generator creates a symphonic video clip from output of the recorder. The generator generates a collage of the concurrently activated video segments and a mix of concurrently activated audio tracks according to the timing of the user activation and deactivation for each activated video segment.

Moreover, in accordance with a preferred embodiment of the present invention, the programmable mobile device includes a screen large enough to display at least two multiple selectable video segments and speakers to play the associated audio of the selectable video segments.

There is provided in accordance with a preferred embodiment of the present invention, a method for symphonic video clip generation implementable on a programmable mobile device. The method includes displaying on a soundboard of the programmable mobile device, multiple individually selectable video segments, each occupying a portion of the soundboard and each having a single associated audio track, recording user activation and deactivation of the selectable video segments, playing the segments once activated where any of the activated segments play concurrently and generating the symphonic video clip as a collage of the concurrently activated video segments and a mix of concurrently activated audio tracks according to timing of the user activation and deactivation for each activated video segment.

Moreover, in accordance with a preferred embodiment of the present invention, the selecting includes touching the part of screen displaying the video segments.

Further, in accordance with a preferred embodiment of the present invention, the playing time for each selected segment is according to the activation of the selection.

Still further, in accordance with a preferred embodiment of the present invention, the generating includes displaying each video segment as it is selected in a portion of the screen, where the size of the portion is a function of the number of currently selected video segments.

Still further, in accordance with a preferred embodiment of the present invention, the symphonic video clip is provided to another cellular telephone, a social website, an email address or a video website.

Still further, in accordance with a preferred embodiment of the present invention, the method includes mixing the symphonic video clip with sequences from an original video clip with which it is associated.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a single video clip and it associated multiple audio tracks constructed and operated in accordance with the present invention;

FIG. 2 is a schematic illustration of a symphonic video clip generator constructed and operated in accordance with the present invention;

FIG. 3 is a flowchart illustration of a method of generating selectable video segments constructed and operated in accordance with the present invention;

FIG. 4 is a flowchart illustration of a method of generating a symphonic video clip constructed and operated in accordance with the present invention;

FIG. 5 is a schematic illustration of the alignment of audio tracks associated with selectable video segments constructed and operated in accordance with the present invention; and

FIGS. 6A-6D are schematic illustrations of different views of an exemplary symphonic video clip.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that using a cell-phone or any programmable mobile device, such as iPads, iPods and other forms of tablet, for music only, does not take advantage of all of the capabilities that these devices allow. This is especially true for those devices that have large displays which are also touchscreens. Applicants have further realized that the computing capabilities of these devices may allow for a user to create video clips with audio that are a mash of pre-existing videos, or user-created videos, together with a mix of their associated audio tracks to produce a symphonic video clip.

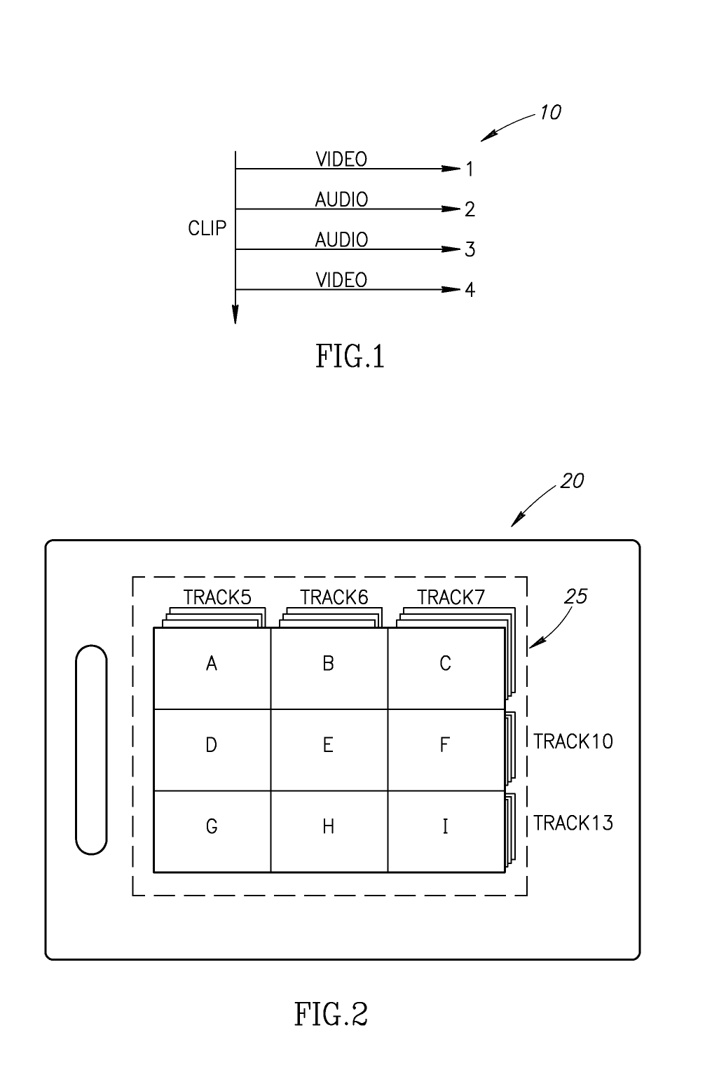

It will be appreciated that a single video clip such as that illustrated in FIG. 1 may be associated with multiple audio tracks. For example, an electronic music clip 10 may be associated with video 1 and multiple audio tracks 2-4, each representing a different musical instrument, playing simultaneously to create rhythm and tempo. For example, audio track 2 may be associated with drums, audio track 3 may be associated with an electric guitar, and audio track 4 may be associated with cymbals.

Reference is now made to FIG. 2, which illustrates a symphonic video clip generator 20. Generator 20 may be implemented as a software application and may operate on a computer or relatively large-screened mobile device, such as a cell-phone running the Android operating system or a product commercially available from Apple Inc. of the United States, such as an iPhone, iPod or iPad. Symphonic video clip generator 20 may also comprise a soundboard 25, displayed on the screen, to enable a user to select and combine multiple video segments, each segment having a single track of music associated therewith, thereby to generate a single “symphonic” video clip of multiple video segments showing at the same time with their associated tracks playing together.

FIG. 2 also illustrates nine different selectable video segments, labeled A through I, which may be available to the user and which may be displayed on soundboard 25. Each selectable video segment may be a pre-existing video clip, or a segment of a pre-existing video, or may be user-generated. Each may be played once-only or run continuously in a loop. All the selectable video segments may be displayed on the soundboard simultaneously and may be played in parallel. Each selectable video segment may have a track of a piece of music associated therewith, in this example, tracks 5-13. As further illustrated in FIG. 2, selectable video segment A may be associated with track 5, selectable video segment B may be associated with track 6, etc. The middle video clip, selectable video segment E, may have the bass line which is track 8. It will be appreciated that there is no limit to the number of selectable video segments that may be made available, and that the number of available clips may be greater than the number that can be shown on the soundboard at one time. In the latter case, it will be appreciated that standard selection mechanisms may be used to choose which selectable video segments will appear on the soundboard at any time.

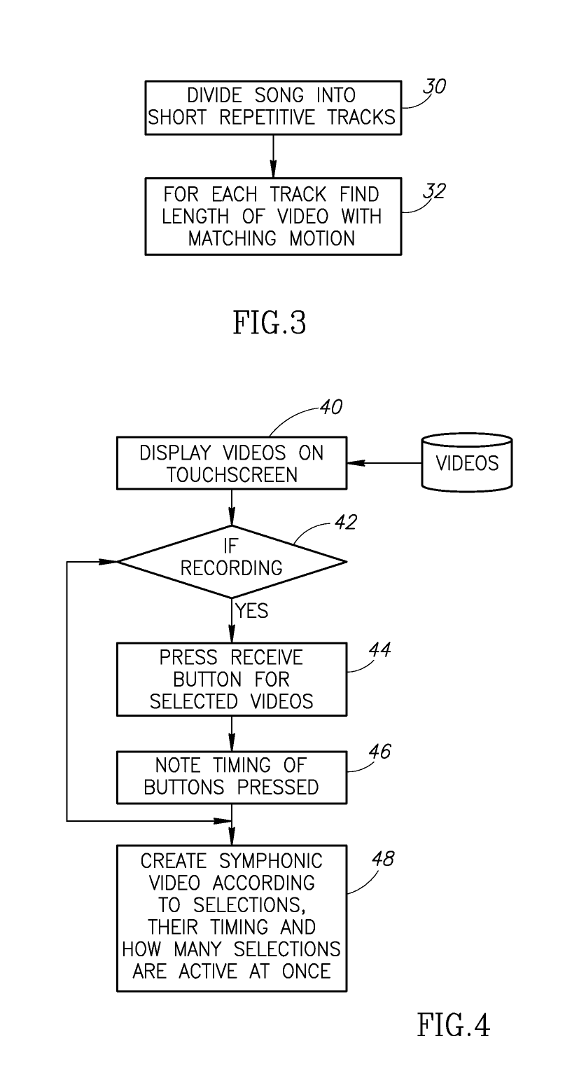

Reference is now made to FIG. 3, which illustrates an exemplary method of generating selectable video segments, typically using pre-existing tools available on the device being used or on a connected computer or server. In step 30, a short length of an audio signal of a song of interest, typically starting and stopping on a beat, may be divided into its separate tracks. In step 32, a video-stream, such as a video of a concert playing the song, or any other video-stream of interest, may be divided into separate sections according to the length of the required audio track. Each section of video may show an action therein which may match the sound action of the track with which it is to be associated. Thus, if the track has a sudden cymbal crash, the matching video may have some appropriate action to match the moment of the crash in the music. The separate selectable video segments may then be stored, to be accessed by generator 20.

Reference is now made to the flowchart of FIG. 4, which illustrates the symphonic video clip generation process. Generator 20 may begin the process by displaying (step 40) the starting image of each available selectable video segment on soundboard 25. It will be appreciated that although the videos of the selectable video segments are not yet shown playing, their associated audio tracks may begin to play in the background within their fixed loops in mute mode. Thus, all the audio tracks may be aligned with each other, as described in detail herein below, but the user does not yet hear anything.

When recording (step 42) is activated by the user, generator 20 may start recording the user's selections, typically for a total predetermined length of time or for a manual, user-defined length of time.

Once recording has been activated (step 42), any of the selectable video segments may be tapped (step 44), i.e. selected, by the user. A first touch may activate a selectable video segment while a second touch may deactivate it.

Once a video segment has been activated, it may start to play its associated video and may unmute its associated audio track so that the user is able to hear the associated track. When a segment is selected, its video will begin to play from wherever the audio loop is. For example, if a segment has an audio and video loop of 3 seconds and the segment is activated 2 seconds into its loop, the video will begin to play at the 2 second position and not from the beginning. The unmuted audio track will also be heard from 2 seconds into its loop. Once the segment has been de-activated, the associated audio track may continue to play, but in muted mode again until reselected.

It will be appreciated that user selections may be at any time within the predetermined length of recording time until the recorder stops or is stopped recording. An exemplary recording length may be about 30 seconds long.

It will be further appreciated that in order to enable a quick response to activations and to ensure good application performance, and also to save on storage space, each of the available selectable video segments may be broken down into frames and played as an animation of the frames rather than as a video. For example, the animation may show the frames at 24 frames/second, which may be a lower resolution.

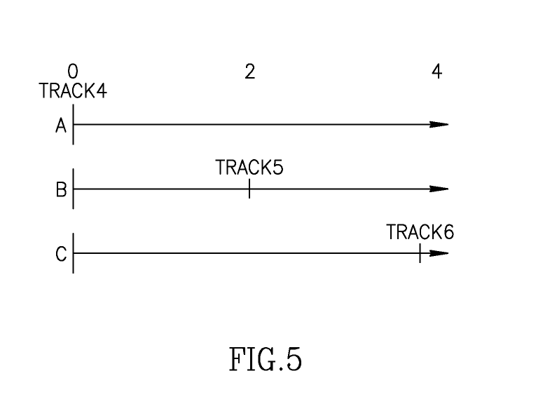

Reference is now made to FIG. 5, which illustrates the alignment of audio tracks 4, 5, and 6 associated with selectable video segments A, B, and C. It will be appreciated that if selectable video segment A is selected at time 0, its audio track will begin to play from the beginning If selectable video segment B is added to the mix after 2 sec, the audio track of B (which is playing in the background in mute mode) will become unmuted and will begin to play at 2 seconds into its loop. Thus, when selectable video segment C is added to the mix at 4 sec, its audio track may begin to play at 4 seconds into its loop, etc. Thus, the beats of tracks 4, 5 and 6 may remain aligned and the resulting combined audio may be more palatable to the ear.

The operating system of the device in use may indicate to generator 20 which area of the soundboard was selected and generator 20 may determine which selectable video segment was activated or deactivated as a result. Generator 20 may also note (step 46) the time that the selectable video segment was activated or deactivated. It will be appreciated that more than one selectable video segment may be activated at any one time.

It will be further appreciated that activation (both recording and selection of segments) may be performed differently according to the device in use, which may range from a graphical pushbutton or touch screen to physically moving the device. Navigation may be performed with the use of a mouse or keys.

Once the predetermined length of total recording time has ended, generator 20 may generate (step 48) the symphonic video clip. The finished symphonic video clip may show each selectable video segment that was activated during the recording stage and may play its associated audio track according to the order and timing in which they were selected and/or deselected. For example, if selectable video segment A was selected to play for 10 seconds, in the finished 30 second-long symphonic video clip it will play for 10 seconds before disappearing from the screen. The associated audio track will also only be heard for 10 seconds.

It will be appreciated that video segment A may be played within the finished symphonic video clip as a video and not as the animated gif that was played on soundboard 25, ensuring a higher resolution.

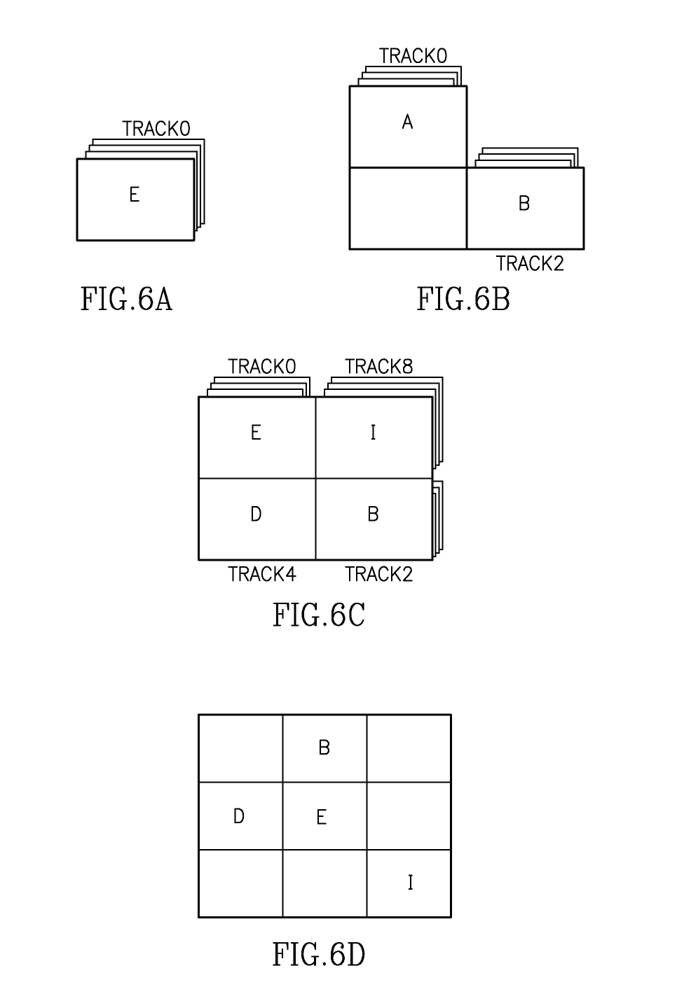

Reference is now made to FIGS. 6A, 6B, 6C and 6D, which illustrate different views of an exemplary symphonic video clip. In this example, selectable video segment E is selected first as illustrated in FIG. 6A and thus, the symphonic video clip begins by showing selectable video segment E and playing its associated audio track 8, in “full display area” mode. Reference is now made to FIG. 6B, which illustrates the addition of selectable video segment B, which was activated by the user a few seconds after selectable video segment E. Thus, at this point in the symphonic video clip, selectable video segment B is also shown and its audio track, audio track 6, is added to the audio signal. Therefore, both selectable video segments are shown, each occupying a portion, for example, one half, of the display area. Both audio tracks are also superimposed on each other and played simultaneously to create a new melody.

Reference is now made to FIG. 6C, which illustrates the addition of another two selectable video segments to the current combination, selectable video segment D and selectable video segment I. The display area now shows all four selectable video segments playing, each in a portion, i.e., a quarter, of the display area. It will be appreciated that if more video clips were added, they would also be shown, but the portion of the display area that they may occupy may be smaller. For example, for 5-9 video clips, each may occupy only 1/9^{th} of the display area, as in the initial display. The finished symphonic video clip may appear as a form of live collage, with video clips repeatedly appearing and disappearing, with a single associated track comprising a changing mix of the associated selected tracks.

It will be appreciated that the video displays in FIGS. 6A, 6B, and 6C are exemplary only. An alternative embodiment to the present invention may display the various sequences in their original location as illustrated in FIG. 6D. Another alternative embodiment would be to create a dynamic mélange of the selected videos, displaying them in ways that match or emphasize the selected audio tracks. Other embodiments are possible and are also part of the present invention.

It will be appreciated that the area of the screen occupied by each selectable video segment as they play may also be pre-determined as to their size and position on the screen.

In a further embodiment, symphonic video clip generator 20 may include a unit to receive user generated selectable video segments with or without associated audio tracks. If there are no associated audio tracks, the user generated, selectable video segments may come with an indication as to which available audio tracks 4-13 may be associated with them for use as audio. Generator 20 may then provide these selectable video segments as the imagery associated with one or more of the available audio tracks. It will be appreciated that user-generated, selectable video segments may include videos found on, or generated from, pictures and videos belonging to friends of the user and may be obtained from content shared by said friends, for example on social networks, such as Facebook.

In another embodiment, selectable video segments may be created from the same video clip, providing segments that may have different audio tracks but identical video.

In a further alternative embodiment to the present invention, different selectable video segments may be grouped together, for example, according to the type of music of their associated audio tracks (such as classical or South American etc.). These groupings may be saved for further and continuous use by generator 20 and may be selected for presentation on a soundboard before the recording stage.

In yet another embodiment, novel user-interface actions may be used, such as shaking the host device to activate generator 20 and/or tilting it to add new videos. These capabilities are typically dependent on what is available and expected on the host device.

In accordance with a preferred embodiment of the present invention, the user may store the generated symphonic video clip on any programmable mobile device, may provide it to family and friends in an email, may upload it to a social website, such as Facebook, may send it to Twitter, may upload it to YouTube for others to play, etc. and/or may use it as a video ringtone on the user's cell-phone.

U.S. Pat. No. 7,761,816, assigned to the common assignee of the present invention and incorporated herein in its entirety by reference, defines a variation of a video clip ringtone in which the video clip is chosen by the calling party, to be displayed on the called handset.

U.S. Pat. No. 7,761,816 also discloses a community server, an Internet-based server that allows users to choose video clip clips to be distributed to their friends (or “buddies”). This patent discusses a variety of other opportunities to present a video clip. For example at the end of a call between two handsets, each might see a video clip: one chosen by the user of that phone, or one chosen by the user of the other phone, or one chosen by the community server.

Prior patent applications U.S. 60/816,888 and 60/829,896 and their utility application U.S. Ser. No. 11/768,989, also assigned to the common assignee of the present invention, describe a method for users to upload video clip clips to the community server. For example, the generated symphonic video clip may be uploaded to the server for transmission to the cell-phones of the user's buddies. In this way, the symphonic video clip may be shown to the buddy or buddies when they are in contact with the user.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.)

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A symphonic video clip generator implementable on a programmable mobile device, the generator comprising:
a soundboard, displayable on a screen of said programmable mobile device, said soundboard displaying multiple individually selectable video segments, each occupying a portion of said screen and each having a single associated audio track;
a recorder to record user activation and deactivation of said selectable video segments; said segments playing once activated and any said activated segments playing concurrently; and
a generator to create a symphonic video clip from output of said recorder, said generator generating a collage of said concurrently activated video segments and a mix of concurrently activated audio tracks according to timing of said user activation and deactivation for each said activated video segment.

2. The symphonic video clip generator according to claim 1 where the programmable mobile device comprises a screen large enough to display at least two multiple said selectable video segments and speakers to play said associated audio of said selectable video segments.

3. A method for symphonic video clip generation implementable on a programmable mobile device, the method comprising:
displaying on a soundboard of said programmable mobile device, multiple individually selectable video segments, each occupying a portion of said soundboard and each having a single associated audio track;
recording user activation and deactivation of said selectable video segments;
playing said segments once activated wherein any said activated segments play concurrently; and
generating said symphonic video clip as a collage of said concurrently activated video segments and a mix of concurrently activated audio tracks according to timing of said user activation and deactivation for each said activated video segment.

4. The method according to claim 3 wherein said selecting comprises touching the part of screen displaying said video segments.

5. The method according to claim 3 wherein playing time for each said selected segment is according to the activation of the selection.

6. The method according to claim 3 wherein said generating comprises:
displaying each video segment as it is selected in a portion of said screen, wherein the size of said portion is a function of the number of currently selected video clips.

7. The method according to claim 3 and also comprising providing said symphonic video clip to one of the following: another cellular telephone, a social website, an email address and a video website.

8. The method according to claim 3 and also comprising mixing said symphonic video clip with sequences from an original video clip with which it is associated.
